(19) United States
(12) Patent Application Publication
(10) Pub. No.: US 2024/0089111 A1
(43) Pub. Date: Mar. 14, 2024

(54) REMOTE ATTESTATION

(71) Applicant: International Business Machines Corporation, Armonk, NY (US)

(72) Inventors: Daniel Blum, Stuttgart (DE); Patrick Joseph Callaghan, Vestal, NY (US); Joseph Douglas Harvey, Binghamton, NY (US); Nicholas Tufano, Poughkeepsie, NY (US)

(21) Appl. No.: 17/940,962

(22) Filed: Sep. 8, 2022

(51) Int. Cl. H04L 9/32; G06F 8/65

(52) U.S. Cl. CPC H04L 9/3234; G06F 8/65; H04L 9/3236; H04L 2209/127

(57) ABSTRACT

In one general embodiment, a computer-implemented method includes performing a firmware update on a hardware component of a computer system. A hash value associated with the update of the firmware is collected, and added to Platform Control Registers (PCRs) of multiple Trusted Platform Module (TPMs) of the computer system. The hash value is logged in a log file. At a predetermined time, PCR values are received from the TPMs. The PCR values are compared to determine whether all PCR values match. In response to one of the PCR values not matching, a warning is issued.

### BACKGROUND

The present invention relates to remote attestation, and more specifically, this invention relates to remote attestation that enables redundancy and high availability.

Remote attestation allows an authorized entity to detect changes to a computer. Remote attestation is usually combined with public-key encryption and other security mechanisms like nonces, so that the information sent can only be read by the programs that requested the attestation, and not by an eavesdropper, as well as cannot be altered by a man in the middle or used in replay attacks.

In a computing system, remote attestation may be used to verify the integrity of files comprising the system. For example, a hardware Trusted Platform Module (TPM) may be used to accumulate hashes that become the basis of attesting to a deterministic sequence of those hashes. The goal of this is to reliably identify a particular level of software/configuration/files/etc. on a system.

### SUMMARY

A computer-implemented method, in accordance with one embodiment, includes performing a firmware update on a hardware component of a computer system. A hash value associated with the update of the firmware is collected, and added to Platform Control Registers (PCRs) of multiple Trusted Platform Module (TPMs) of the computer system. The hash value is logged in a log file. At a predetermined time, PCR values are received from the TPMs. The PCR values are compared to determine whether all PCR values match. In response to one of the PCR values not matching, a warning is issued.

A computer program product for attestation of firmware in a computer system, in accordance with one embodiment, comprising one or more computer readable storage media, and program instructions collectively stored on the one or more computer readable storage media, the program instructions comprising program instructions to perform the foregoing method.

A computer-implemented method, in accordance with another embodiment, includes performing a firmware update on a hardware component of a computer system. A value associated with the update of the firmware is collected and added to Platform Control Registers (PCRs) of multiple Trusted Platform Module (TPMs) of the computer system. The value is logged in a log file. Installation of a new hardware component having a TPM is detected. A PCR value of the TPM of the new hardware component is synchronized with the PCR values of the TPMs already in the system using the log file.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a diagram of a tiered data storage system, in accordance with one embodiment of the present invention.

FIG. 3 is a diagram of an illustrative system architecture employing remote attestation, in accordance with one embodiment.

FIG. 4 is a flow chart of a process, in accordance with one embodiment.

FIG. 5 is a flow chart of a process, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for remote attestation.

In one general embodiment, a computer-implemented method includes performing a firmware update on a hardware component of a computer system. A hash value associated with the update of the firmware is collected, and added to Platform Control Registers (PCRs) of multiple Trusted Platform Module (TPMs) of the computer system. The hash value is logged in a log file. At a predetermined time, PCR values are received from the TPMs. The PCR values are compared to determine whether all PCR values match. In response to one of the PCR values not matching, a warning is issued.

In another general embodiment, a computer program product for attestation of firmware in a computer system comprising one or more computer readable storage media, and program instructions collectively stored on the one or more computer readable storage media, the program instructions comprising program instructions to perform the foregoing method.

In another general embodiment, a computer-implemented method includes performing a firmware update on a hardware component of a computer system. A value associated with the update of the firmware is collected and added to Platform Control Registers (PCRs) of multiple Trusted Platform Module (TPMs) of the computer system. The value is logged in a log file. Installation of a new hardware component having a TPM is detected. A PCR value of the TPM of the new hardware component is synchronized with the PCR values of the TPMs already in the system using the log file.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as remote attestation code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

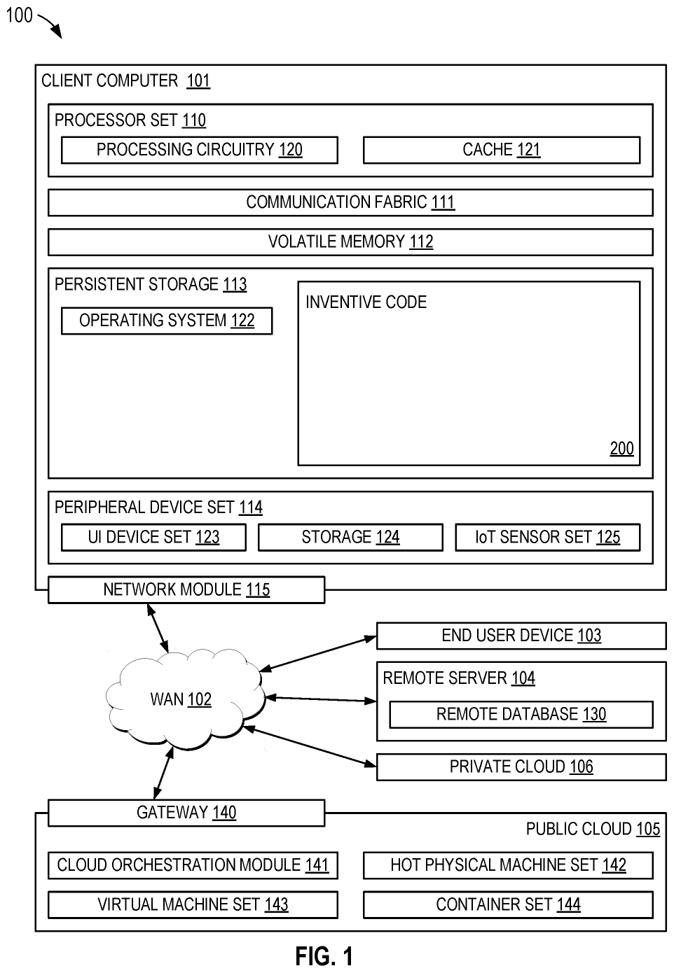

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

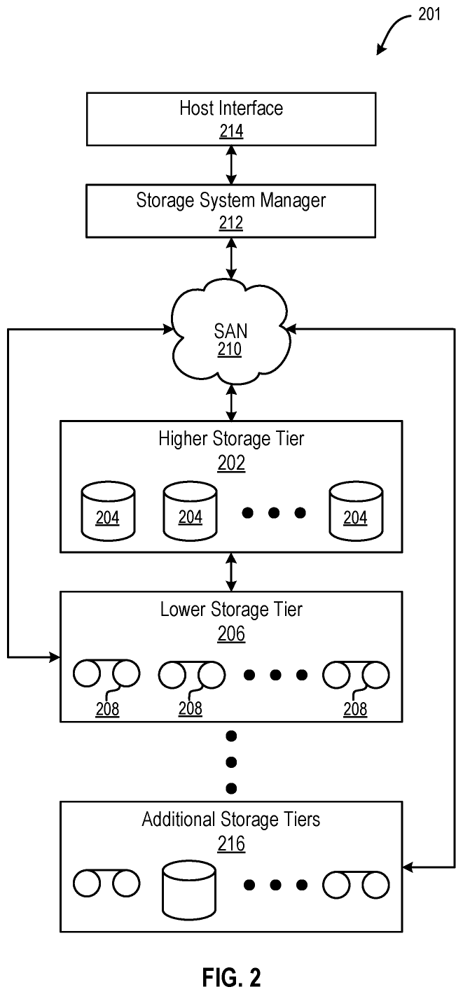

Now referring to FIG. 2, a storage system 201 is shown according to one embodiment. Note that some of the elements shown in FIG. 2 may be implemented as hardware and/or software, according to various embodiments. The storage system 201 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 201. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a storage area network (SAN), as shown in FIG. 2, or some other suitable network type. The storage system manager 212 may also communicate with one or more host systems (not shown) through a host interface 214, which may or may not be a part of the storage system manager 212. The storage system manager 212 and/or any other component of the storage system 201 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 201 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the embodiments presented herein.

According to some embodiments, the storage system (such as 201) may include logic configured to receive a request to open a data set, logic configured to determine if the requested data set is stored to a lower storage tier 206 of a tiered data storage system 201 in multiple associated portions, logic configured to move each associated portion of the requested data set to a higher storage tier 202 of the tiered data storage system 201, and logic configured to assemble the requested data set on the higher storage tier 202 of the tiered data storage system 201 from the associated portions.

Of course, this logic may be implemented as a method on any device and/or system or as a computer program product, according to various embodiments.

As noted above, in a computing system, remote attestation may be used to verify the integrity of files comprising the system. For example, a hardware-based Trusted Platform Module (TPM) may be used to accumulate hashes that become the basis of attesting to a deterministic sequence of those hashes. The goal of this is to reliably identify a particular level of software/configuration/files/etc. on a system.

There are several problems with existing solutions in this area. First, such solutions do not provide high availability. For instance, TPM hardware cannot be exchanged on the fly without interruption to the operation of the system. Second, such solutions lack redundancy. Particularly, data is only available in one place and cannot be reconstructed in the event of a failure. This single point of failure renders such systems unreliable. Third, existing solutions require group-based decision making. Often times in distributed systems such as blockchain, node consensus on the state of the system is required in order to establish a truth. This is cumbersome, and only as good as the blockchain itself.

Various embodiments presented herein overcome the shortcomings in the state of the art by providing attestation in a highly available, redundant environment that does not require group-based decision making.

To this end, some embodiments of the present invention provide hardware based trust. Particularly, trust is established based on no external dependencies, e.g., no conferring with other nodes. Only a single TPM is needed. The TPM hardware itself is implicitly trusted because it is essentially untamperable; it is the authoritative source of information. Accordingly, the system environment remains intact and trusted, even down to a single TPM. Moreover, the information needed for attestation attest is self-contained; it can be maintained within as little as a single node on a network. Unlike block miners, or other distributed/certificate-based architectures, there is no need to confer with any other nodes to establish a truth. Accordingly, no network is needed in some aspects. Moreover, because the TPM(s) are trusted, the number of TPMs can be scaled out while remaining resilient to failures, because one can look at any TPM, compare it to a log file (described below), and determine based on the comparison whether or not the correct sequence of occurrences has occurred, and thereby allow validation of the state that the TPM represents, e.g., an untampered state of the system.

Further embodiments of the present invention provide redundancy, making the system overall more reliable. Particularly, multiple TPMs may all be synchronized with one another by a broker service. The broker service itself need not retain any special knowledge needed to authoritatively answer whether the TPM states are consistent or trusted. Rather, the broker service can use the log file to keep the TPMs in sync; and even if they are not in sync, the log file can be used to determine if any of the individual TPMs are valid. The redundancy also provides a benefit in that TPMs can be swapped in and out as needed with no downtime and no loss of a “trusted state.”

Further embodiments of the present invention enable more efficient recovery via use of a log file. The log file may be stored in the system. However, an externally managed (and untrusted) logfile can be validated by existing TPMs and used to synchronize new TPMs. A benefit of this is that it prevents unneeded hardware swapping, e.g., by rebuilding individual TPMs and checking their integrity. Moreover, in preferred embodiments, any (and all) TPMs can validate an arbitrary log file to determine whether it contains a valid sequence of operations. Even if the log is deleted or destroyed, the state of the TPMs in the group are still maintained. This permits the detection of tampering because the TPMs are observed to be in a non-initial state, even if the log does not agree.

Some embodiments enable the ability to perform off-site backups of the log file for recovery purposes. For example, if a TPM fails or needs to be replaced, the log file may be used to update the hash values in the TPM to the current state, thereby synchronizing the new TPM to the other TPMs known to be valid from the log.

Moreover, some embodiments of the present invention provide a plurality of the above-listed features. For example, various embodiments of the present invention provide “security attestation” redundancy and high availability by maintaining a log file that preserves the history of the attestation-related events that previously interfaced with the hardware. If one part of the hardware setup fails, the part may be replaced via a service repair action. The new hardware part may be added to the running computing system after one or more attestation events have occurred, and the new hardware part will be updated with the previously logged history to bring the state of the new hardware part up to the level of the other plurality of hardware parts that are maintaining the attestation values. In addition, the update of the state of the hardware part is done in a manner so that any attack on the history log file is detected, and if detected, a notification may be output, e.g., to the owner or administrator of the computing system. The attack is detected, in one approach, because the state of the new hardware part, after being updated with the history, is compared to the one or more other hardware parts that were not replaced. If the state is not identical to that maintained on the other parts, an attack may be assumed.

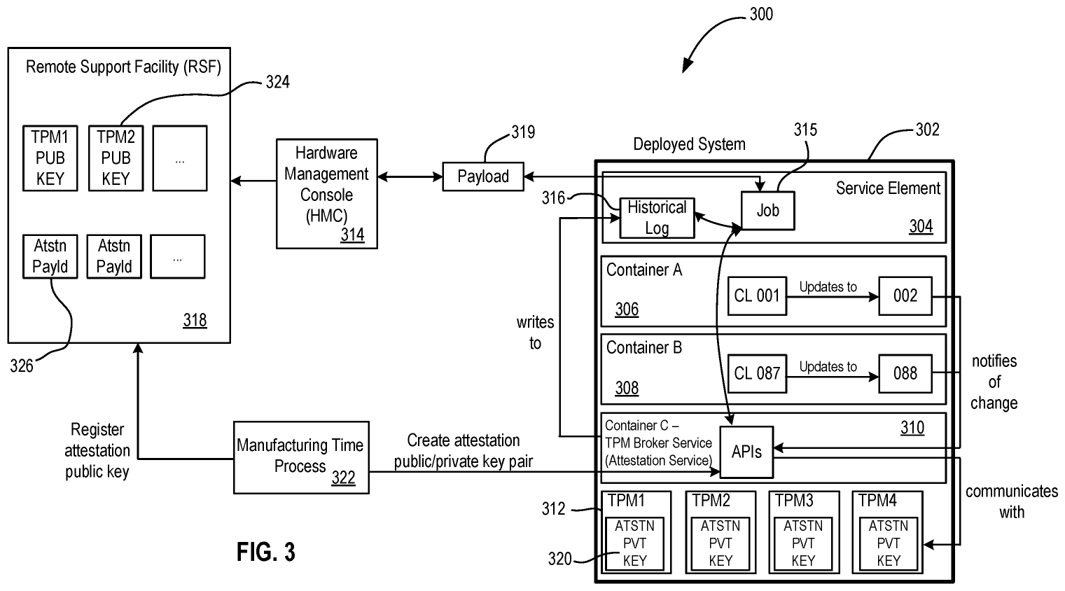

Presented by way of example only, FIG. 3 depicts an illustrative system architecture 300 employing remote attestation, in accordance with one embodiment. As an option, the present system architecture 300 may be implemented in conjunction with features from any other embodiment listed herein, such as those described with reference to the other FIGS. Of course, however, such system architecture 300 and others presented herein may be used in various applications and/or in permutations which may or may not be specifically described in the illustrative embodiments listed herein. Further, the system architecture 300 presented herein may be used in any desired environment.

A deployed system 302 includes a service element 304; Containers A and B 306, 308; Container C, which is or includes a TPM broker service (attestation service) 310; and a plurality of TPMs 312. Note that any number of containers may be present.

The deployed system 302 is a hardware system, so over time, the code that's running in Containers A and/or B is replaced. Particularly, at some point, the deployed system 302 is serviced to update the levels of code (firmware) running on particular hardware components of the system. As shown, for example, Container A updates from Code Level (CL) 001 to 002. Such updating can occur, e.g., when an updated firmware is made available for one or more of the components, e.g., via a patch. In one approach, the task to apply service is performed on the hardware management console (HMC) 314. The HMC, for example, may download the patch(es), and in turn, send the patch(es) to a job management module 315 of the service element 304.

Similarly, Container C 310 (the broker service) can itself be subject to the same attestation process. When the code in Container C 310 is updated, Container C 310 can notify itself (via the same process other containers use) that it has been updated with a new code level, and this too can be documented in the log file. This strengthens the chain of trust.

The service element 304 may be part of the deployed system 302, or may be a separate computer running alongside the deployed system 302. The service element 304 communicates the patches to the various components so that they can install the new firmware. Typically, the firmware is installed without bringing down the software in what may be referred to as a concurrent update. Note however that the deployed system 302 may have some components in which software is brought down during firmware updating of said components.

The broker service 310 is configured to accept incoming requests to broker TPM actions on behalf of other services. Exemplary processes performed by the broker service 310 are set forth below. The broker service 310 may use any type of connection, such as a device connection, network connection, or DBUS connection to interact with the plurality of TPM devices 312 through a consolidated TPM interface. This TPM interface is able to service commands corresponding to the TPMs 312. The broker service 310 also communicates with a persistence service, e.g., the service element 304, capable of storing the aforementioned log file. Preferably, the broker service 310 is primarily single-threaded to enforce that all incoming requests are serviced in a FIFO-fashion. Threading may be used during certain operations, such as TPM firmware updates to expedite the operation. The broker service 310 may also maintain an active list available of TPMs 312 to expedite operations. The broker service 310 may also perform periodic checks against known TPMs to ensure their hash level has not changed from the expected value. For example, when a hardware device having TPMs loses power and its PCRs are reset to zero this will be logged and rectified.

As part of the updating process, signatures are checked to make sure that the update is trusted firmware. Moreover, a value is added to each TPM 312, preferably in a way that a value in a register of the TPM 312 is extended with that new value. In this way, the sequence of values stored in a register of a TPM 312 can be checked to verify that the exact sequence of values matches the history of installs. Thus, by extending the value stored in the TPM 312 every time a firmware update occurs, one can be certain that an exact sequence of actions was taken, with respect to the firmware, because the TPM 312 will keep track of those actions. A hacker cannot spoof that, without control of the code. If a hacker tried to load a different file in that sequence, the anomaly in the sequence of values would be noticed, because an incorrect value would be extended in the TPM 312. Accordingly, the sequence of values stored in the TPMs 312 can be used to help ensure the integrity and the level of the firmware running on the system, because these hashes extend the value in the TPM 312 as firmware is loaded, and then using the value on can validate that the firmware running in a container associated with the TPM 312 is exactly the desired code at the exact level expected. Moreover, because the TPMs 312 are trusted, one can be assured of this in a secure way.

The architecture 300 provides high availability, in that the values are stored in multiple TPMs 312, i.e., at least two TPMs. For example, if the deployed system 302 has eight TPMs 312, the value is added to all of the TPMs 312 so that their running values match each other. Accordingly, if one of the TPMs fails, the value from any of the other TPMs 312 can be used to validate the firmware state of the deployed system 302. Moreover, the value from any of the other TPMs 312 can be used to bring a new TPM up to the same level as the other TPMs 312. This is a vast improvement over use of a single TPM to store values, where if that TPM fails, the ability to validate the level of firmware on the system is lost.

Preferably, the value is a hash value associated with the update. For example, the hash may be derived from the firmware, e.g., may be a hash of the applied code update. In another approach, the hash value may be generated from some other value provided by or otherwise associated with the firmware, etc. Any known hashing algorithm may be used to create hash values.

Each TPM 312 preferably has a Platform Control Register (PCR) of known type. Preferably the PCR is a type that can accumulate the values, preferably by appending the new value to the end of the values already accumulated in sequence.

The new value is also logged in a log file, e.g., of the historical log 316. When notified of new code applied to a CPC subsystem, the broker service 310 stores a log of the hash in addition to extending the TPM PCR values with the provided hash. The sequence of these logs can be used to reconstruct the PCR value for a TPM 312 at any point.

The historical log 316 is shown residing in the service element 304, but may be located anywhere in the architecture 300, on a different system entirely, in a cloud, etc. Noting that the deployed system preferably remains up during firmware updates, and a new value is created each time firmware is updated, there may be years' worth of values stored in the TPMs 312 and the log 316. An exemplary format for the log 316 is as follows:

| interface LogDocument { | |
|---|---|
| version: 1 | |
| entries: Entries | |
| sequence: Array<key of Entries> | |
| } | |
| interface Entries { | |
| [entry_id: string]: { | // Unique log entry id as map key |
| entry_id: string | // Same unique log entry id as map key |
| timestamp: number | // Time at which log entry was created |
| pcr_number: 11 | // Default PCR of 11 |
| hash_id: string | // Identifier for the basis of the hash Value |
| hash_value: string | // Actual code level hash value |

pcr_extend_input: string // pcr_extend_input = sha384(

// hash_id + hash_value + hash_value.length
// )
// This value is provided for debug purposes

resulting_pcr_value: string // Pre-computed value expected in all PCRs

// post-extend

}
}

Preferably, this data does not come from any user input sources and is also not displayed on any user interfaces provided by this service; therefore, it is not possible for this data to represent a code-injection risk. Also preferably, if the format of any log files changes across service versions, the service will perform all appropriate conversions to the new log file format.

Some embodiments have the ability to perform off-site backups of the log file storing the log 316 for recovery purposes. For example, if a TPM 312 fails or needs to be replaced, the log file may be used to update the hash values in the TPM to the current state, thereby synchronizing the new TPM to the other TPMs 312 known to be valid from the log 316. In some embodiments, if the log file is lost or corrupted, the off-site backup of the log file can be transmitted to the broker service 310 via the SE 304 and HMC 314.

Upon occurrence of an event, e.g., expiration of a predetermined time period, the values of the TPMs 312 are sent to the remote support facility (RSF) 318 for verification that all of the values match. See Payload 319. The RSF performs the attestation, e.g., verifies that the deployed system 302 is running the latest level of code, and also that it is authentic code. The code can be validated as authentic when the hashes all match and they are signed by the respective TPM 312. If a value from one of the TPMs 312 does not match the other values, an alert can be issued. This mismatch may indicate a problem, such as a hacking attempt, a failure of one of the firmware installations, etc.

The TPMs 312 may use a private key 320 (e.g., ATSTN PVT KEY), that is unique to each TPM 312 and preferably stored in the TPM 312 during a manufacturing time process 322 that creates a public/private key pair. The RSF 318 may store the corresponding public keys (e.g., TPM #PUB KEY) 324, and use the same to verify the attestation payloads 326 (Atstn Payld). For example, when a TPM 312 submits the value of its PCR, it may sign the value with its private key. The RSF uses the public key to validate the signature, and assuming the validation is successful, the RSF then knows that the PCR value was not altered and is authentic.

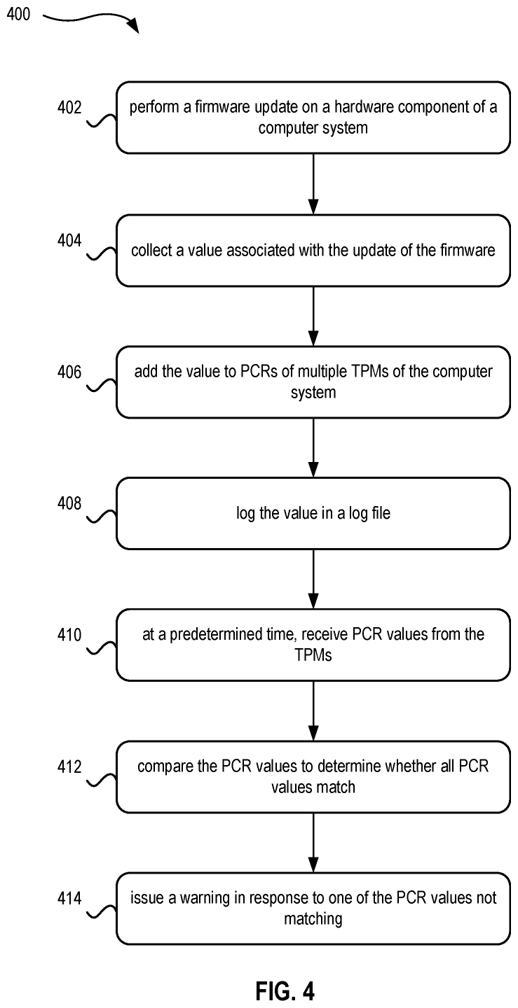

Now referring to FIG. 4, a flowchart of a method 400 is shown according to one embodiment. The method 400 may be performed in accordance with the present invention in any of the environments depicted in FIGS. 1-3, among others, in various embodiments. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by one or more of the computers in the system architecture 300 of FIG. 3, or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4, method 400 may initiate with operation 402, in which a firmware update is performed on a hardware component of a computer system, e.g., the deployed system 302 of FIG. 3. Any known technique for updating firmware may be used and/or adapted for use in operation 402. See the description of FIG. 3, above, for an exemplary firmware update procedure.

In operation 404, a value associated with the update of the firmware is collected. The value may be any value associated with and/or derived from the firmware itself, the update, etc. Preferably, the value is derived from the firmware itself. As noted above, the value may be a hash value of a type conventionally generated upon updating firmware.

In operation 406, the value is added to PCRs of multiple TPMs of the computer system, e.g., by a broker service that synchronizes distribution of the values to the TPMs. As noted above, the value is preferably appended to the value already in the register, such that the register has a particular state based on the sequence of firmware updates performed on the computer system. Also, as above, each TPM may be implicitly trusted.

The value is also logged in a log file. See operation 408. As above, the log file may be externally managed (external to the modules having the TPMs, and in some embodiments, external to the computer system). The value is preferably logged in a similar manner as the values stored in the PCRs of the TPMs, so that the value in the log file may be compared to the values of the TPMs for verification of the TPMs and/or the logs.

In operation 410, at a predetermined time, PCR values are received from the TPMs. The predetermined time may be any trigger or condition that causes operation 410 to be performed. For example, the predetermined time may correspond to expiration of a predefined time period (e.g., an interval), a time triggered by occurrence of an event such as detection of a firmware update, etc.

In operation 412, the PCR values are compared to one another, or equivalently to the value in the log file, to determine whether all PCR values match.

In operation 414, a warning is issued in response to one of the PCR values not matching.

In response to detecting installation of a new hardware component having a TPM, the PCR value of the TPM of the new hardware component is preferably synchronized with the PCR values of the TPMs already in the system using the log file, or equivalently a value from another of the TPMs, such that the PCR value of the TPM of the new hardware component is updated to match the PCR values of the other TPMs. Preferably, after the update, operations 410-414 are performed to compare the PCR value of the TPM of the new hardware component to at least one of the other PCR values to determine whether the PCR values match, and issue a warning if they do not.

At a second predetermined time, the log file may be validated using a PCR value from at least one of the TPMs. The second predetermined time may be the first predetermined time, or may be some other time.

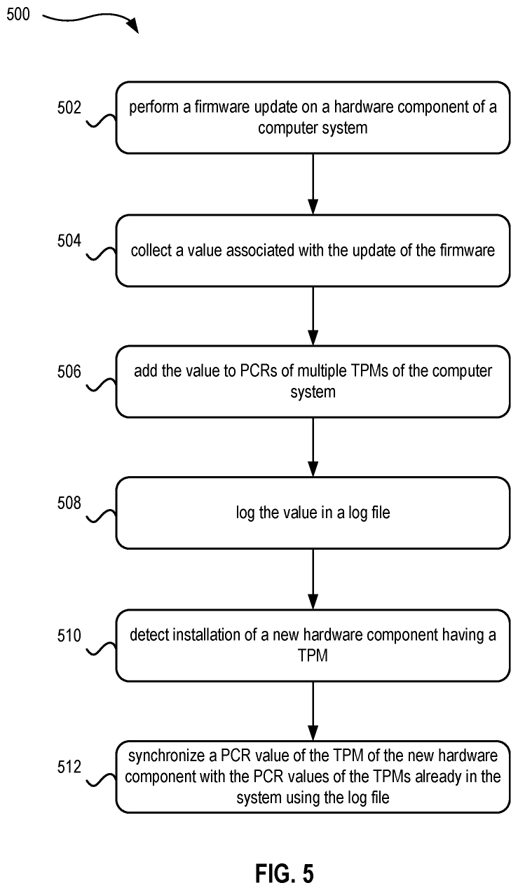

Now referring to FIG. 5, a flowchart of a method 500 is shown according to one embodiment. The method 500 may be performed in accordance with the present invention in any of the environments depicted in FIGS. 1-4, among others, in various embodiments. Of course, more or fewer operations than those specifically described in FIG. 5 may be included in method 500, as would be understood by one of skill in the art upon reading the present descriptions.

Each of the steps of the method 500 may be performed by any suitable component of the operating environment. For example, in various embodiments, the method 500 may be partially or entirely performed by one or more of the computers in the system architecture 300 of FIG. 3, or some other device having one or more processors therein. The processor, e.g., processing circuit(s), chip(s), and/or module(s) implemented in hardware and/or software, and preferably having at least one hardware component may be utilized in any device to perform one or more steps of the method 500. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 5, method 500 may initiate with operation 502, where a firmware update is performed on a hardware component of a computer system.

In operation 504, a value corresponding to the firmware is collected.

In operations 506 and 508, the value is added to PCRs of multiple TPMs of the computer system, and the value is logged in a log file.

In operation 510, the installation of a new hardware component having a TPM is detected.

In operation 512, a PCR value of the TPM of the new hardware component is synchronized with the PCR values of the TPMs already in the system using the log file, or equivalently with a value from another of the TPMs.

A method performed at boot time, in accordance with one embodiment, is described below. The method may be performed in accordance with the present invention in any of the environments depicted in FIGS. 1-5, among others, in various embodiments. Of course, more or fewer operations than those specifically described below may be included in the method, as would be understood by one of skill in the art upon reading the present descriptions.

Each of the steps of the method may be performed by any suitable component of the operating environment. For example, in various embodiments, the method may be partially or entirely performed by one or more of the computers in the system architecture 300 of FIG. 3, or some other device having one or more processors therein. The processor, e.g., processing circuit(s), chip(s), and/or module(s) implemented in hardware and/or software, and preferably having at least one hardware component may be utilized in any device to perform one or more steps of the method. Illustrative processors include, but are not limited to, a central processing unit (CPU), an application specific integrated circuit (ASIC), a field programmable gate array (FPGA), etc., combinations thereof, or any other suitable computing device known in the art.

When the service is started up, it will perform initial hash reconciliation by querying all known subsystems for their current hash values (via the Code Level HashProvider) and comparing them to the persisted log. All known TPMs within the system are identified, and the current PCR value from each of the known TPMs are obtained and compared to the current subsystem hash values.

Differences in hash values may be resolved by searching the log for each of the hash values obtained from the TPMs. If the hash is the most-recent entry in the log, nothing is done for that TPM. If the hash is found, but is not the most recent entry, the PCR is extended by applying all hashes newer than the one found to the TPM in question in an appropriate order, e.g., an order determined based on a “sequence” array stored in the log file. Preferably, an additional prerequisite before applying the hash(es) to a TPM is a requirement that there is at least one TPM for which the log file matches its PCR value. Otherwise, a decision may be made not to trust the log file since its data is not supported by any existing TPMs. Assuming the hash is applied to the TPM, all TPMs are in sync with the current log contents. If there are new subsystem hashes available that are not in the log, log entries are created for them and each TPM's PCR is extended with the latest subsystem hashes. The order in which concurrent entries are placed is at the discretion of the broker service and is recorded in the log.

A method for responding to a hardware change, in accordance with one embodiment, is described below. The method may be performed in accordance with the present invention in any of the environments depicted in FIGS. 1-5, among others, in various embodiments. Of course, more or fewer operations than those specifically described below may be included in the method, as would be understood by one of skill in the art upon reading the present descriptions.

Each of the steps of the method may be performed by any suitable component of the operating environment. For example, in various embodiments, the method may be partially or entirely performed by one or more of the computers in the system architecture 300 of FIG. 3, or some other device having one or more processors therein. The processor, e.g., processing circuit(s), chip(s), and/or module(s) implemented in hardware and/or software, and preferably having at least one hardware component may be utilized in any device to perform one or more steps of the method. Illustrative processors include, but are not limited to, a central processing unit (CPU), an application specific integrated circuit (ASIC), a field programmable gate array (FPGA), etc., combinations thereof, or any other suitable computing device known in the art.

When the broker service is notified that the TPM hardware within the system has changed, it may perform the following steps. All known TPMs may be determined, e.g., by querying a TPM metadata provider for all known TPMs. For each existing TPM, its PCR value is validated as follows. If its PCR value is not as expected based on the log and other TPMs, an error is logged. If its PCR value is zero, the entire sequence of hashes from the log is applied onto its PCR. A check is performed to ensure that the resulting hash matches the hash in the latest log entry.

For each newly-discovered TPM, the entire sequence of hashes from the log is applied onto its PCR. A check is made to ensure that the resulting hash matches the hash in the latest log entry.

For each now-non-existent TPM, that TPM is removed from the internally managed list of known TPMs.

A method for responding to a firmware update, in accordance with one embodiment, is described below. The method may be performed in accordance with the present invention in any of the environments depicted in FIGS. 1-5, among others, in various embodiments. Of course, more or fewer operations than those specifically described below may be included in the method, as would be understood by one of skill in the art upon reading the present descriptions.

Each of the steps of the method may be performed by any suitable component of the operating environment. For example, in various embodiments, the method may be partially or entirely performed by one or more of the computers in the system architecture 300 of FIG. 3, or some other device having one or more processors therein. The processor, e.g., processing circuit(s), chip(s), and/or module(s) implemented in hardware and/or software, and preferably having at least one hardware component may be utilized in any device to perform one or more steps of the method. Illustrative processors include, but are not limited to, a central processing unit (CPU), an application specific integrated circuit (ASIC), a field programmable gate array (FPGA), etc., combinations thereof, or any other suitable computing device known in the art.

When the broker service is notified that a new code level has been applied to a subsystem, it will perform the following operations. A new log entry containing the details outlined in the log entry format is created in the persisted log. The expected resulting PCR value is pre-computed after performing the extend on a TPM. For each known TPM, the PCR value is extended with the new hash provided in the event, and the new PCR value is obtained from the TPM. All of the new values are compared for equality across all of the known TPMs with the pre-computed value. If at any point during normal operation, it is discovered that at least one TPM disagrees on what the current value of the PCR should be, an error log is created, reflecting the operation that failed along with the PCR values of all known TPMs and any other appropriate details.

When all or part of the system loses power, its TPM PCRs may become zeroed out. As long as there is at least one TPM with a non-zero value in its PCR, the persisted log can be used to reconstruct all other TPMs. This is accomplished by ordering all log entries appropriately and extending the PCR value by each of the entries' hashes in sequence. The result should be a PCR value which is equivalent to the value of all other TPMs that are already up-to-date.

If a situation is encountered in which all TPMs are determined to have a zero value in their PCR, the persisted log can be zeroed out as well and repopulated with the current hash values for each of the known subsystems before allowing any other TPM operations to be brokered by the service.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
performing a firmware update on a hardware component of a computer system;
collecting a hash value associated with the update of the firmware;
adding the hash value to Platform Control Registers (PCRs) of multiple Trusted Platform Module (TPMs) of the computer system;
logging the hash value in a log file;
at a predetermined time, receiving PCR values from the TPMs;
comparing the PCR values to determine whether all PCR values match; and
in response to one of the PCR values not matching, issuing a warning.

2. The computer-implemented method of claim 1, wherein each TPM is implicitly trusted.

3. The computer-implemented method of claim 1, wherein the TPMs are synchronized using a broker service.

4. The computer-implemented method of claim 1, comprising:
detecting installation of a new hardware component having a TPM; and
synchronizing a PCR value of the TPM of the new hardware component with the PCR values of the TPMs already in the system using the log file.

5. The computer-implemented method of claim 4, comprising:
receiving PCR values from the TPMs including the TPM of the new hardware component;
comparing the PCR value of the TPM of the new hardware component to one of the other PCR values to determine whether the PCR values match; and
in response to the PCR value of the TPM of the new hardware component not matching the other PCR value, issuing a second warning.

6. The computer-implemented method of claim 1, wherein the log file is externally managed; and comprising: at a second predetermined time, validating the log file using a PCR value from at least one of the TPMs.

7. A system, comprising:
one or more processors; and
logic integrated with the one or more processors, executable by the one or more processors, or integrated with and executable by the one or more processors, the logic being configured to perform the method of claim 1.

8. A computer program product for attestation of firmware in a computer system, the computer program product comprising one or more computer readable storage media, and program instructions collectively stored on the one or more computer readable storage media, the program instructions comprising:
program instructions to perform a firmware update on a hardware component of a computer system;
program instructions to collect a value associated with the update of the firmware;
program instructions to add the value to Platform Control Registers (PCRs) of multiple Trusted Platform Module (TPMs) of the computer system;
program instructions to log the value in a log file;
program instructions to, at a predetermined time, receive PCR values from the TPMs;
program instructions to compare the PCR values to determine whether all PCR values match; and
program instructions to issue a warning in response to one of the PCR values not matching.

9. The computer program product of claim 8, wherein each TPM is implicitly trusted.

10. The computer program product of claim 8, wherein the TPMs are synchronized using a broker service.

11. The computer program product of claim 8, comprising:
program instructions to detect installation of a new hardware component having a TPM; and
program instructions to synchronize a PCR value of the TPM of the new hardware component with the PCR values of the TPMs already in the system using the log file.

12. The computer program product of claim 11, comprising:
program instructions to receive PCR values from the TPMs including the TPM of the new hardware component;
program instructions to compare the PCR value of the TPM of the new hardware component to one of the other PCR values to determine whether the PCR values match; and
program instructions to issue a warning in response to the PCR value of the TPM of the new hardware component not matching the other PCR value.

13. The computer program product of claim 8, wherein the log file is externally managed; and comprising: at a second predetermined time, validating the log file using a PCR value from at least one of the TPMs.

14. A computer-implemented method, comprising:
performing a firmware update on a hardware component of a computer system;
collecting a value associated with the update of the firmware;
adding the value to Platform Control Registers (PCRs) of multiple Trusted Platform Module (TPMs) of the computer system;
logging the value in a log file;
detecting installation of a new hardware component having a TPM; and
synchronizing a PCR value of the TPM of the new hardware component with the PCR values of the TPMs already in the system using the log file.

15. The computer-implemented method of claim 14, wherein each TPM is implicitly trusted.

16. The computer-implemented method of claim 14, wherein the TPMs are synchronized using a broker service.

17. The computer-implemented method of claim 14, comprising:
receiving PCR values from the TPMs including the TPM of the new hardware component;
comparing the PCR values to determine whether all PCR values match; and
in response to one of the PCR values not matching, issuing a warning.

18. The computer-implemented method of claim 14, wherein the log file is externally managed; and comprising: at a second predetermined time, validating the log file using a PCR value from at least one of the TPMs.

19. A system, comprising:
one or more processors; and
logic integrated with the one or more processors, executable by the one or more processors, or integrated with and executable by the one or more processors, the logic being configured to perform the method of claim 14.

20. A computer program product for attestation of firmware in a computer system, the computer program product comprising one or more computer readable storage media, and program instructions collectively stored on the one or more computer readable storage media, the program instructions comprising:
program instructions to perform the method of claim 14.
